(19) United States
(12) Patent Application Publication
(10) Pub. No.: US 2019/0007193 A1
(43) Pub. Date: Jan. 3, 2019

(54) METHOD FOR ADJUSTING PARAMETERS OF PHASE LOCKED LOOP, BLUETOOTH MODULE AND BLUETOOTH SYSTEM

(71) Applicant: SMARTECH WORLDWIDE LIMITED, Tortola (VG)

(72) Inventor: Jingquan Fu, Hong Kong (CN)

(21) Appl. No.: 16/018,040

(22) Filed: Jun. 25, 2018

(30) Foreign Application Priority Data
Jun. 30, 2017 (CN) 201710521450.9

(51) Int. Cl. H04L 7/033; H04L 7/00; H04L 27/227; H04W 4/80; H04L 27/20

(52) U.S. Cl. CPC H04L 7/0331; H04L 7/0087; H04L 27/20; H04W 4/80; H04L 27/2272

(57) ABSTRACT

A method for adjusting parameters of a phase locked loop includes: receiving an ID packet from a Bluetooth master device, the ID packet comprising a preamble; calculating a carrier frequency offset according to the preamble of the ID packet; and correcting a deviation of the phase locked loop according to the carrier frequency offset.

### CROSS-REFERENCE TO RELATED APPLICATIONS

The present disclosure claims priority to Chinese Patent Application No. 201710521450.9, filed with the Chinese Patent Office on Jun. 30, 2017, titled “METHOD FOR ADJUSTING PARAMETERS OF PHASE LOCKED LOOP, BLUETOOTH MODULE, BLUETOOTH SLAVE DEVICE AND BLUETOOTH SYSTEM”, the entire contents of which are incorporated herein by reference.

### TECHNICAL FIELD

The present disclosure relates to the technical field of Bluetooth, and in particular, relates to a method for adjusting parameters of a phase locked loop, a Bluetooth module and a Bluetooth system.

### BACKGROUND

In Bluetooth communication, a high precision requirement is imposed on the Bluetooth clock of devices, and generally the deviation needs to be controlled within 20 ppm. The clock of a Bluetooth chip or Bluetooth module is provided by an output signal having a fixed frequency output by a phase locked loop. The reference clock of the phase locked loop is determined by the Bluetooth chip. Therefore, to ensure that the precision of the Bluetooth clock satisfies the requirement of 20 ppm, the crystal oscillator used on the Bluetooth chip or Bluetooth module also needs to satisfy the requirement of 20 ppm.

However, the crystal oscillator having a deviation less than 20 ppm is very expensive. In some occasions, to reduce the cost of the Bluetooth chip or Bluetooth module, the crystal oscillator having lower precision may be used. In this case, in the mass production of the chips, the parameters of the phase locked loop need to be adjusted (the phase locked loop is a small fractional phase locked loop) to satisfy the requirement on the precision of the Bluetooth clock.

### SUMMARY

Embodiments of the present disclosure provide a method for adjusting parameters of a phase locked loop. The method includes: receiving an ID packet from a Bluetooth master device, the ID packet including a preamble; calculating a carrier frequency offset according to the preamble of the ID packet; and correcting a deviation of the phase locked loop according to the carrier frequency offset.

Embodiments of the present disclosure further provide a Bluetooth module. The Bluetooth module includes: a phase locked loop, a phase locked loop adjusting unit, and a Bluetooth signal processing unit; wherein the phase locked loop is configured to provide a clock system; the Bluetooth signal processing unit is configured to receive an ID packet from a master device, the ID packet including a preamble, and calculate a carrier frequency offset according to the preamble in the ID packet; and the phase locked loop adjusting unit is configured to correct a deviation of the phase locked loop according to the carrier frequency offset.

Embodiments of the present disclosure further provide a Bluetooth system. The Bluetooth system includes a Bluetooth master device in a scanning state and a Bluetooth slave device in a response state; wherein the Bluetooth master device is configured to broadcast an ID packet, the ID packet comprises a preamble;

the Bluetooth slave device is configured to receive the ID packet, calculate a carrier frequency offset according to the preamble of the ID packet, correct a deviation of the phase locked loop according to the carrier frequency offset and return a response data packet.

### BRIEF DESCRIPTION OF THE DRAWINGS

One or more embodiments are illustrated by way of example, and not by limitation, in the figures of the accompanying drawings, wherein components having the same reference numeral designations represent like components throughout. The drawings are not to scale, unless otherwise disclosed.

FIG. 1 is a schematic diagram of an application environment according to an embodiment of the present disclosure;

FIG. 2 is a time sequence diagram of connection/synchronization between a Bluetooth master device and a Bluetooth slave device;

FIG. 3 is a schematic diagram of an ID packet;

FIG. 4 is a structural block diagram of a Bluetooth module according to an embodiment of the present disclosure;

FIG. 5 is a structural block diagram of a demodulation circuit according to an embodiment of the present disclosure;

FIG. 6 is a flowchart of a method for adjusting parameters of a phase locked loop according to an embodiment of the present disclosure; and

FIG. 7 is a flowchart of a demodulation method according to an embodiment of the present disclosure.

### DETAILED DESCRIPTION

In order to make the objectives, technical solutions, and advantages of the present disclosure clearer, the present disclosure is further described in detail below by reference to the embodiments and the accompanying drawings. It should be understood that the specific embodiments described herein are only intended to explain the present disclosure instead of limiting the present disclosure.

Bluetooth is a point-to-point or point-to-multipoint topological structure. However, interactions therebetween are all based on a physical channel. Point-to-multipoint may share one physical channel. In a piconet based on the same physical channel, a hardware device may serve as a master device or a slave device. The specific device role may be defined by the device randomly, to implement the corresponding control function (one piconet has only one master device). Nevertheless, an intersection is allowed to exist between different piconets. That is, the slave device in one piconet may serve as the master device on another piconet.

In discovery and synchronization processes of Bluetooth devices, two Bluetooth devices may be connected in the following states: a inquiry/inquiry scanning state, a paging/paging scanning state and a connecting state.

The inquiry/inquiry scanning state means finding a surrounding device by a Bluetooth device via query. An inquiring device may send a new frequency for query at an interval of 312.5 ms, and an inquired device may select a new monitoring frequency at an interval of 1.28 s. A general inquiry access code (GIAC) low access part (LAP) is used as an inquiry address between the querying device and the queried device. According to the specifications of the Bluetooth standards, the general inquiry access code is 0x9E8B33.

The paging/paging scanning state is a state that the Bluetooth device is paging a target device to join a piconet thereof when the address of the device needed to connect has been known.

FIG. 1 illustrates an application environment according to an embodiment of the present disclosure. As illustrated in FIG. 1, the application environment includes: a user 10, a first Bluetooth device 20 and a second Bluetooth device 30.

The user 10 may be a group having the same or similar operation behaviors in any number, for example, a family, a work group or individuals. The user 10 may interact with the first Bluetooth device 20 by using one or a plurality of user interaction devices of any suitable type, for example, a mouse, a keypad, a remote control, a touch screen, a motion sensing camera, or a smart wearable device, input instructions or control the first Bluetooth device 20 to perform one or a plurality of operations.

The first Bluetooth device 20 may be a suitable smart electronic device of any type, for example, a smart phone, a tablet computer, a personal computer, a laptop computer, or any other terminal device. The first Bluetooth device 20 is capable of accommodating more advanced use demands of the user, and is an electronic device which is manufactured with a higher cost. The system clock thereof has a higher precision, and refer to an accurate system clock.

The first Bluetooth device 20 may enter the scanning/scanning inquiry state as a master device according to a user instruction, generate a synchronization word by using the general inquiry access code, and broadcast a series of ID packets for inquiry.

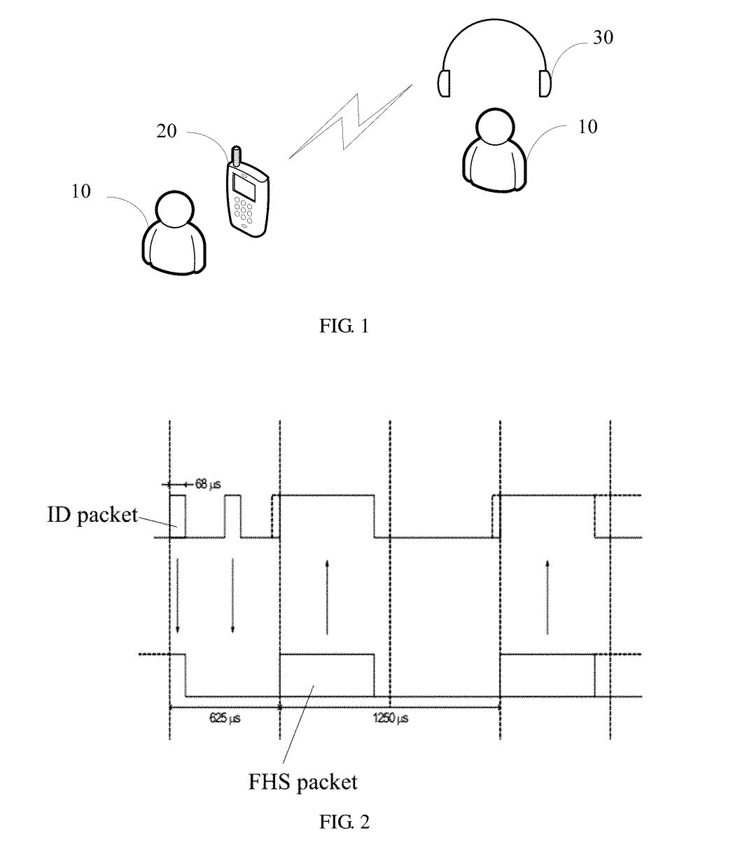

The second Bluetooth device 30 may monitor an inquiry request from the first Bluetooth device 20 as a Bluetooth slave device in the scanning/scanning inquiry state. Upon receiving an correct ID packet, the second Bluetooth device 30 may return an FHS packet including device information to the first Bluetooth device 20. A time sequence of the data packets sent between the first Bluetooth device 20 and the second Bluetooth device 30 is as illustrated in FIG. 2.

In an embodiment of the present disclosure, the second Bluetooth device 30 may calculate a carrier frequency offset between the Bluetooth master device and the Bluetooth slave device according to the information of the ID packet, and then correct a deviation of the phase locked loop of the Bluetooth slave device according to the carrier frequency offset.

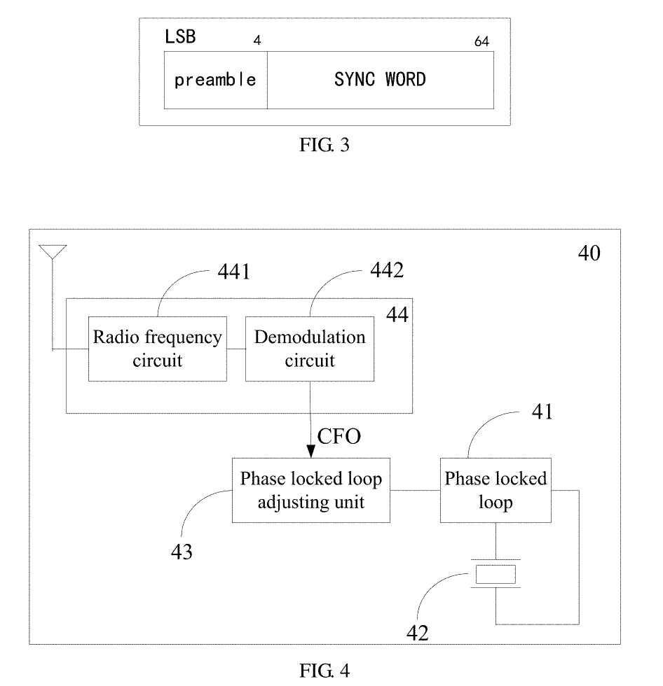

FIG. 3 illustrates a data format of the ID packet. The ID packet is a general packet with access code, including a 4-bit preamble and a 64-bit synchronization word (SYNC WORD). In the ID packet, the synchronization word is originated from a 24-bit address, and is generally 0x9E8B33 in the inquiry/inquiry scanning state.

The preamble is determined by the least significant bit (LSB) of the followed synchronization code, and is a fixed 4-symbol 0-1 mode. The preamble is used for assist DC compensation, with the sequence of “0101” (when the LSB is 0) or “1010” (when the LSB is 1).

In this embodiment, the second Bluetooth device 30 may specifically calculate a carrier frequency offset between the first Bluetooth device and the second Bluetooth device according to the preamble in the ID packet.

The terms “master device” and “slave device” used herein are merely intended to represent roles of hardware devices in the piconet. In practical operation, the device role may be exchanged according to the actual needs. For example, upon the deviation correction, the second Bluetooth device 30 may also be changed to the master device, and is used as a clock reference basis for other Bluetooth devices which need to correct the phase locked loop deviation.

FIG. 1 only illustrates two users 10, one first Bluetooth device 20 and one second Bluetooth device 30. However, a person skilled in the art would understand that in practical operation, the application environment may further include more users 10, more first Bluetooth devices 20 and more second Bluetooth devices 30.

The first Bluetooth device 20 and the second Bluetooth device 30 are both devices which have a Bluetooth module or module set capable of implementing the Bluetooth communication function. In one embodiments, the Bluetooth module or module set may be used as an independent integrated circuit chip. In other embodiments, the Bluetooth module or module set may also be used as a function module integrated in a complete integrated circuit chip. For brevity of description, hereinafter the “Bluetooth module” is used to represent an integrated circuit which is capable of implementing the Bluetooth communication function.

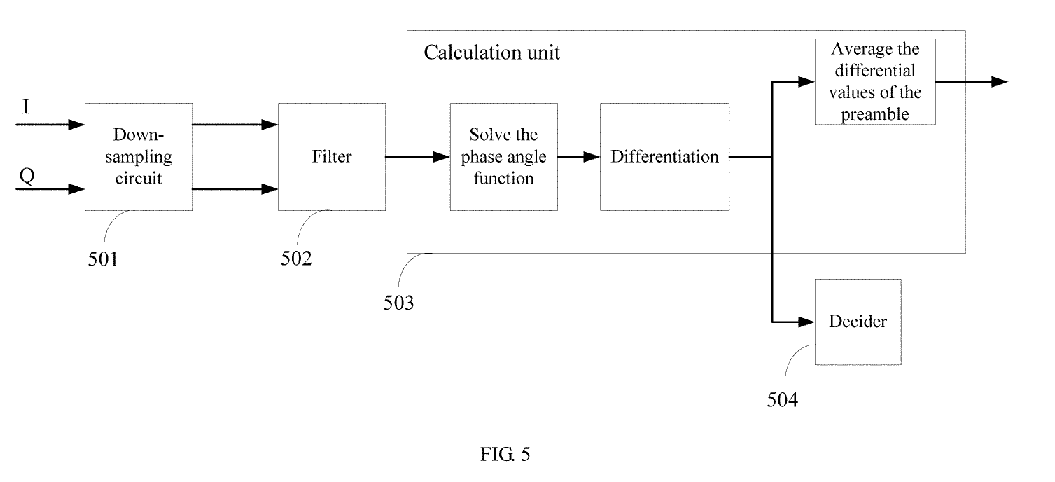

FIG. 4 is a functional block diagram of a Bluetooth module 40 according to an embodiment of the present disclosure. In this embodiment, the Bluetooth module 40 may include: a phase locked loop (PLL) 41, a crystal oscillator 42, a phase locked loop adjusting unit 43, and a Bluetooth signal processing unit 44.

The phase locked loop adjusting unit 43 and the Bluetooth signal processing unit 44 is consist of a set of hardware circuits and processors which is common used to perform corresponding function in the integrated circuit field.

The Bluetooth signal processing unit 44 is a function module configured to receive and process Bluetooth radio frequency signals. The Bluetooth signal processing unit 44 outputs data information loaded in the carrier signals upon performing a series of signal processing for the Bluetooth radio frequency signals.

In this embodiment, the Bluetooth signal processing unit 44 may calculate and output the carrier frequency offset according to the preamble included in the ID packet from the Bluetooth master device.

Specifically, as illustrated in FIG. 4, the Bluetooth signal processing unit 44 may include a radio frequency circuit 441 and a demodulation circuit 442.

The radio frequency circuit 441 receives the radio frequency signals from the Bluetooth master device via an antenna, for examples, the carrier signals loaded with the ID packet. Afterwards, the radio frequency signals are amplified by a low noise amplifier (LNA), and converted into baseband signals. Finally, by using an analog-to-digital converter, analog signals are converted into digital signals, and provided to the demodulation circuit 442.

The phase locked loop 41 is connected to the crystal oscillator 42. The phase locked loop 41 used the crystal oscillator 42 as a reference clock to form an output signal having a predetermined frequency which is used as the clock of the Bluetooth module 40. When the precision of the crystal oscillator 42 can not satisfy the requirement of the Bluetooth module, the phase locked loop adjusting unit 43 corrects the frequency offset of the output signal of the phase locked loop 41 to meet the requirement, by the carrier frequency offset provided from the demodulation circuit 442.

In the embodiments, as illustrated in FIG. 5, the radio frequency circuit 442 may specifically include: a down-sampling circuit 501, a filter 502 and a calculation unit 503. The calculation unit 503 may be any suitable electronic circuit having corresponding calculation capabilities.

The baseband signals output from the radio frequency circuit 441 may be represented by two components, an in-phase signal (I) and an orthogonal signal (Q) that are perpendicular to each other. The down-sampling circuit 501 down-samples the two signals to acquire corresponding down-sampling signals.

The filter 502 is configured to perform channel selection filtering for the down-sampling signals. Upon the channel selection filtering, the two signals are input to the calculation unit 503 to solve the phase angle function. The calculation unit 503 performs differentiation upon completion of solving the phase angle function.

Finally, the differential values of the preamble are averaged to obtain the carrier frequency offset (CFO). The differential value of the calculation unit 503 may also be output to a decider 504 for decoding to acquire corresponding binary data.

In this embodiment, the phase locked loop 41 is specifically a fractional phase locked loop, whose precision may reach 10 Hz. However, the reference clock of the phase locked loop is provided by the crystal oscillator 42. When the crystal oscillator 42 has a deviation, the phase locked loop also has a corresponding deviation. The phase locked loop adjusting unit 43 acquires the carrier frequency offset via calculation, and adjusts a frequency division ratio of the phase locked loop, such that the deviation of the crystal oscillator is compensated. As a result, when a 100 ppm crystal oscillator is used, the frequency deviation may still be control in ±75 KHz. The Bluetooth clock provided by the phase locked loop satisfies the precision requirement of 20 ppm.

The Bluetooth module 40 carries out adaptive adjustment for deviation of the phase locked loop according to the information of the carrier frequency offset included in the received ID packet. Therefore, in an embodiment of the present disclosure, the Bluetooth module 40 may use a crystal oscillator having low precision or great deviation, which thus reduces the manufacture cost. However, there is not necessary to measure the output signal frequency of the phase locked loop by external instrument during production, even if a low-precision crystal oscillator is used in the Bluetooth module.

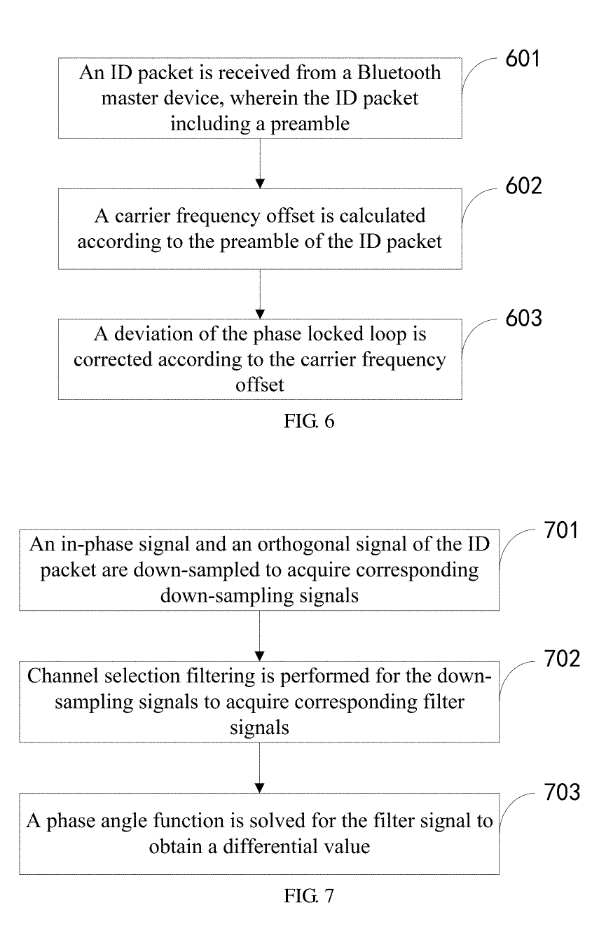

FIG. 6 is a flowchart of a method for adjusting parameters of a phase locked loop applied in the Bluetooth module according to an embodiment of the present disclosure. As illustrated in FIG. 6, the method includes the following steps:

601: An ID packet is received from a Bluetooth master device, wherein the ID packet including a preamble.

The ID packet is a 68-bit shortened access code and used for calling, inquiry, parking and the like, which includes a 4-bit preamble and a 64-bit synchronization word.

602: A carrier frequency offset is calculated according to the preamble of the ID packet.

The carrier frequency offset between the receiver end and the transmitter end calculated according to the preamble of the ID packet. In the Bluetooth 2.1 standards, the preamble has a fixed 4-bit 0-1 mode including the sequence of 1010 or 0101. The preamble is determined by the least significant bit of the synchronization word.

603: A deviation of the phase locked loop is corrected according to the carrier frequency offset.

The carrier frequencies of the receiver end and the transmitter end are also determined by the clock of the device. Therefore, when the transmitter end (that is, the Bluetooth master device) is a reliable clock, for example, a smart phone or a tablet computer, the receiver end may correct the deviation of the phase locked loop thereof according to the carrier frequency offset between the receiver end and the transmitter end.

The deviation of the phase locked loop of the receiver end is generally caused by the deviation of the reference clock provided by the crystal oscillator. In some embodiments, the deviation of the phase locked loop may be corrected by adjusting the frequency division ratio of the phase locked loop according to the carrier frequency offset.

In this embodiment, when the phase locked loop is a fractional phase locked loop, the deviation of the reference clock of the phase locked loop may be compensated by adjusting the frequency division ratio of the phase locked loop, so as to correct the output frequency of the phase locked loop and satisfy the precision requirement (eg. 20 ppm) of the Bluetooth clock.

Bluetooth communication is a wireless communication process, and information is loaded on carrier signals (a modulation process) and sent in the form of a radio frequency signal. After the receiver end receives the modulated signals via the antenna, a series of signal processing needs to be performed to convert the radio frequency signals into baseband signals and then demodulated to extract the information from the carrier signals.

Specifically, as illustrated in FIG. 7, the demodulation process may include the following steps:

701: An in-phase signal and an orthogonal signal of the ID packet are down-sampled to acquire corresponding down-sampling signals.

Wireless signal may be represented by two components, an in-phase signal and an orthogonal signal that are perpendicular to each other. In other words, the amplitude and phase of the wireless signal may be recorded as a dot in a two-dimensional space, and the projections of the vector represented by this dot in the X axis and the Y axis are the in-phase component I and the 90-degree phase shift component Q.

702: Channel selection filtering is performed for the down-sampling signals to acquire corresponding filter signals.

703: A phase angle function is solved for the filter signal to obtain a differential value. After the differential value is obtained, a corresponding binary demodulated signal may be output by using a decider.

In addition, the average value of the differential values of the preamble is the carrier frequency offset (CFO).

In an embodiment of the present disclosure, the deviation of the phase locked loop of the Bluetooth slave device is adjusted based on the clock of the Bluetooth master device as a reference by using the carrier frequency offset in the ID packet. Therefore, when the method for adjusting parameters of a phase locked loop according to an embodiment of the present disclosure is used, the Bluetooth module or the corresponding Bluetooth device may use a low-precision crystal oscillator to reduce the manufacture cost.

In addition, adaptive adjustment according to the carrier frequency of the Bluetooth master device by using the above method for adjusting parameters of a phase locked loop further optimizes the crystal oscillator start-up circuit, the PCB board and the deviation of the phase locked loop, and improves the quality of communication between the Bluetooth module and other Bluetooth devices.

It should be noted that since the apparatus embodiments and the method embodiments are based on the same inventive concept, and technical contents in the method embodiments may also be applied to the apparatus embodiments, which are thus not described herein any further.

A person skilled in the art should be further aware that with reference to the embodiments of the present disclosure disclosed herein, various exemplary Bluetooth communication steps may be implemented in the form of electronic hardware, computer software or a combination thereof. To clearly describe interchangeability between the hardware and software, the above description has generally illustrates the compositions and steps of the various example according to the functions. Whether such functions are implemented in the form of software or hardware depends on the specific application and the design restrictions applied to the entire system.

A person skilled in the art may implement the described functions by using different methods for each specific application. However, such implementation shall not be deemed as going beyond the scope of the present disclosure. The computer software program may be stored in a computer readable storage medium, wherein the computer software program, when being executed, may perform the steps and processes according to the above method embodiments. The storage medium may be any medium capable of storing program codes, such as read-only memory (ROM), a random access memory (RAM), a magnetic disk, or a compact disc-read only memory (CD-ROM).

Described above are exemplary embodiments of the present disclosure, but are not intended to limit the scope of the present disclosure. Any equivalent structure or equivalent process variation made based on the specification and drawings of the present disclosure, which is directly or indirectly applied in other related technical fields, fall within the scope of the present disclosure.

What is claimed is:

1. A method for adjusting parameters of a phase locked loop, comprising:
receiving an ID packet from a Bluetooth master device, the ID packet comprising a preamble;
calculating a carrier frequency offset according to the preamble of the ID packet; and
correcting a deviation of the phase locked loop according to the carrier frequency offset.

2. The method according to claim 1, wherein the correcting a deviation of the phase locked loop according to the carrier frequency offset comprises:
adjusting a frequency division ratio of the phase locked loop according to the carrier frequency offset; and
compensating a deviation of a reference clock of the phase locked loop by adjusting the frequency division ratio of the phase locked loop.

3. The method according to claim 1, wherein the receiving an ID packet from a Bluetooth master device comprises:
receiving a modulated signal of the ID packet; and
demodulating the modulated signal of the ID packet.

4. The method according to claim 3, wherein the demodulating the modulated signal of the ID packet comprises:
down-sampling an in-phase signal and an orthogonal signal of the ID packet to acquire corresponding down-sampling signals;
performing channel selection filtering for the down-sampling signals to acquire corresponding filter signals; and
solving a phase angle function for the filter signal to obtain a differential value.

5. The method according to claim 4, wherein the calculating a carrier frequency offset according to the preamble of the ID packet comprises:
acquiring differential values of the preamble; and
averaging the differential values of the preamble to acquire the carrier frequency offset.

6. A Bluetooth module, comprising: a phase locked loop, a phase locked loop adjusting unit, and a Bluetooth signal processing unit; wherein
the phase locked loop is configured to provide a system clock;
the Bluetooth signal processing unit is configured to receive an ID packet from a master device, the ID packet comprising a preamble, and calculate a carrier frequency offset according to the preamble in the ID packet; and
the phase locked loop adjusting unit is configured to correct a deviation of the phase locked loop according to the carrier frequency offset.

7. The Bluetooth module according to claim 6, wherein the Bluetooth signal processing unit comprises: a radio frequency circuit which is configured to receive a modulated signal of the ID packet and a demodulation circuit which is configured to demodulate the modulated signal of the ID packet.

8. The Bluetooth module according to claim 7, the demodulation circuit comprising: a down-sampling circuit, a filter, and a calculation unit; wherein the down-sampling circuit is configured to down-sampling an in-phase signal and an orthogonal signal of the ID packet to acquire corresponding down-sampling signals;
the filter is configured to perform channel selection filtering for the down-sampling signals to acquire corresponding filter signals; and
the calculation unit is configured to solve a phase angle function for the filter signal to obtain a differential value.

9. The Bluetooth module according to claim 8, wherein the calculation unit is configured to: acquire differential values of the preamble; and average the differential values of the preamble to acquire the carrier frequency offset.

10. The Bluetooth module according to claim 6, wherein the phase locked loop is a fractional phase locked loop.

11. A Bluetooth system, comprising a Bluetooth master device in a scanning state and a Bluetooth slave device in a response state; wherein the Bluetooth master device is configured to broadcast an ID packet, the ID packet comprises a preamble;
the Bluetooth slave device is configured to receive the ID packet, calculate a carrier frequency offset according to the preamble of the ID packet, correct a deviation of the phase locked loop according to the carrier frequency offset and return a response data packet.

12. The Bluetooth system according to claim 11, wherein the Bluetooth slave device is further configure to:
adjust a frequency division ratio of the phase locked loop according to the carrier frequency offset; and
compensate a deviation of a reference clock of the phase locked loop by adjusting the frequency division ratio of the phase locked loop.

13. The Bluetooth system according to claim 11, wherein the Bluetooth slave device is further configure to:
receive a modulated signal of the ID packet; and
demodulate the modulated signal of the ID packet.

14. The Bluetooth system according to claim 13, wherein the Bluetooth slave device is further configure to:
down-sample an in-phase signal and an orthogonal signal of the ID packet to acquire corresponding down-sampling signals;
perform channel selection filtering for the down-sampling signals to acquire corresponding filter signals; and
solve a phase angle function for the filter signal to obtain a differential value.

15. The Bluetooth system according to claim 14, wherein the Bluetooth slave device is further configure to:
acquire differential values of the preamble; and
average the differential values of the preamble to acquire the carrier frequency offset.
